(19) United States
(12) Patent Application Publication
(10) Pub. No.: US 2004/0015555 A1
(43) Pub. Date: Jan. 22, 2004

(54) Automatic internet retrieval apparatus

(76) Inventor: Oren Petrank, Haverfordwest (GB)

Correspondence Address: OREN PETRANK, 83 AUGUSTINE WAY, HAVERFORDWEST, WLS, SA61 1NZ, GB

(21) Appl. No.: 10/351,352

(22) Filed: Jan. 27, 2003

(30) Foreign Application Priority Data
Oct. 17, 2002 (GB) GB 0224149.5
Jan. 31, 2002 (GB) GB 0202230.9

(51) Int. Cl. G06F 15/16

(52) U.S. Cl. 709/206; 709/217

(57) ABSTRACT

The device that automatically calls on an Internet Service Provider or a Remote Computer to retrieve or send electronic mail, information and data, by employing a Random Time Frequency Generator that determines the dialing and re-dialing times between upper and lower time limits, and further divides the allotted time into equal (or unequal) sub windows, equivalent to the ‘number of attempts’ computed by the caller. It eliminates the need of the Internet user to manually repeat the process of engaging and re-engaging the automatic dialer in the User's computer's Modem, Portable Computer or Mobile Phone to connect to the Internet Provider and retrieve and send E-mail and data. It is equipped with a screen Signal function and a Buzzer function to alert the user in the event of successful retrieval or send. The retrieval or send process can be customized to the individual user. The device goes to idle mode when the computer or mobile phone is switched off. It automatically re-engage the last dial program when the computer or mobile phone is re-started.

### BACKGROUND OF THE INVENTION

This invention is designed to eliminate the need of Internet users to manually repeat the process of engaging and re-engaging the automatic dialer in the user's, computer Modem, Portable computer or Mobile phone to connect to the service provider's remote computer in order to retrieve (and send) e-mails and other data or information. The dialing and re-dialing is determined by a Random Time Frequency generator between lower and upper time limits. This application also covers any automatic connection between any two computers for the purpose of retrieval (and sending) of information. This application applies to users of Mobile phones and Portable Personal computers equipped with with Internet access who wishes to engage in automatic redial to retrieve and send e-mails and other information or data via the Internet. This device is automatically triggered as soon as the computer is switched on and it discontinued as soon as the computer is switched off. The advantage of this dialing method, from the point of view of the service provider, is that because of the random nature of the dialing, it is unlikely that the system will become overloaded because a large number of users may choose the same time, such as the top of the hour, as the preferred time for dial and redial.

Dialing and re-dialing method that employs a Random Time Frequency Generator was disclosed in my published patent GB 2 368 231 B, in reference to the playing of pre-recorded messages. In this application, not only the fundamental use is new as it applies to the Internet and has nothing to do with playing pre-recorded message/s, but it also contains new crucial dialing features not disclosed in my published patent. These feature are detailed in the description under the titles: ‘Dial Attempts’, ‘Dial Frequency’ and ‘First Dial’. This application also contains other inventive claims that make this patent application unique.

### SUMMARY OF THE INVENTION

This invention relates to the automatic retrieval (and sending) of e-mail message and any other information or data that can be transferred via the internet by means of automatic dialing and re-dialing by the user's computer's Modem, Mobile phone or Portable P/C equipped with internet connection, into the service provider's remote computer at pre-determined time intervals.

It will enables the caller to insert dialing and re-dialing time instructions via a Random Time Frequency Generator. The device divides the required range between upper and lower time limits into sub-windows that corresponds to the ‘number of attempts’ at which the the Random Time Frequency Generator device will engage in a randomly chosen time to dial the telephone number of the Internet service provider.

This invention allows the user to automatically retrieve (and sending) of data in the same way from any remote computer without the need to make repeated calls manually. This invention also includes the mechanism to draw the attention of the user to any successful retrieval (or sending) by means of visual signal on the computer's or Mobile phone's screen and/or sound signals through the compute's or Mobile phone's speaker/s. This device is automatically triggered as soon as the computer/mobile phone is switched on and it discontinued as soon as the computer/mobile phone is switched off. The computer/mobile phone's timer remains connected to the device to avoid the need to re-program the device each time the computer/mobile phone is re-started.

Flow-Chart 1/3 Illustrates the basic relationship between the Computer, the Device, the Modem or automatic dialer and the Internet Service Provider.

Flow-Chart 2/3 Illustrates the basic relationship between the Device, the Modem or automatic dialer, the User's Portable Computer or Mobile phone and the Service Provider.

Flow-Chart 3/3 Illustrates the basic relationship between the Device, the Modem or automatic dialer, the User's Computer and the Remote Computer

### INTRODUCTION TO THE DRAWINGS

FIG. 1/4 Illustrates the device incorporated into a Personal Computer equipped with Modem, speakers and Internet connection.

FIG. 2/4 Illustrates the device incorporated into a Portable Personal Computer equipped with mobile phone or internet connection and speakers.

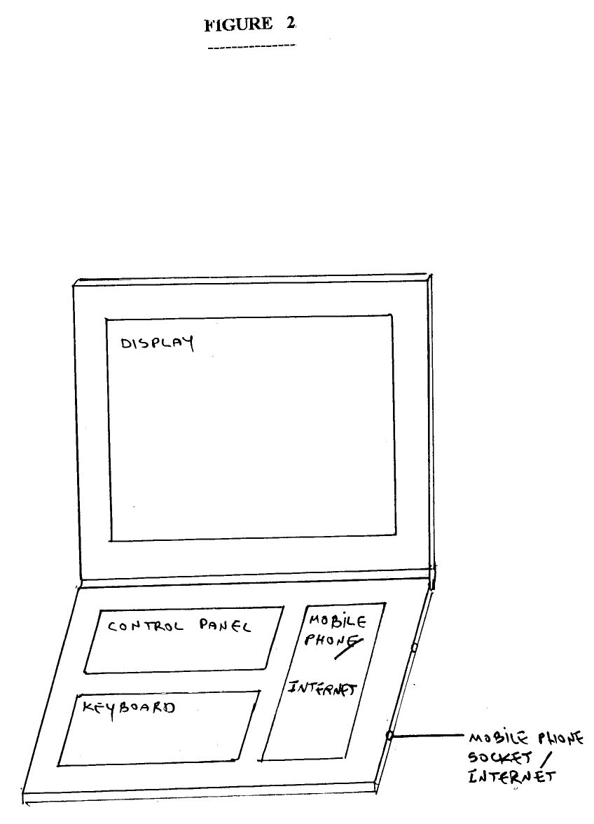

FIG. 3/4 Illustrates the device incorporated into a server/main frame computer with Internet connection. Internet connection can be through a service provider or when the server/main frame computer incorporates the function of Service provider within its own Network.

FIG. 4/4 Illustrates the device incorporated into a mobile phone with internet connection.

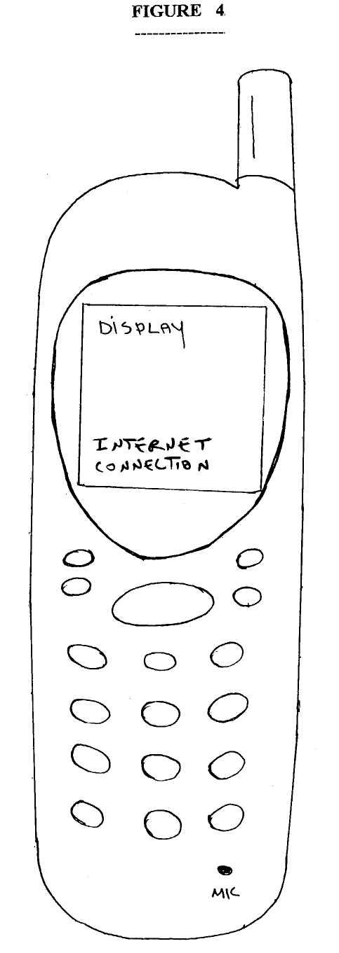

The following pages are not numbered:

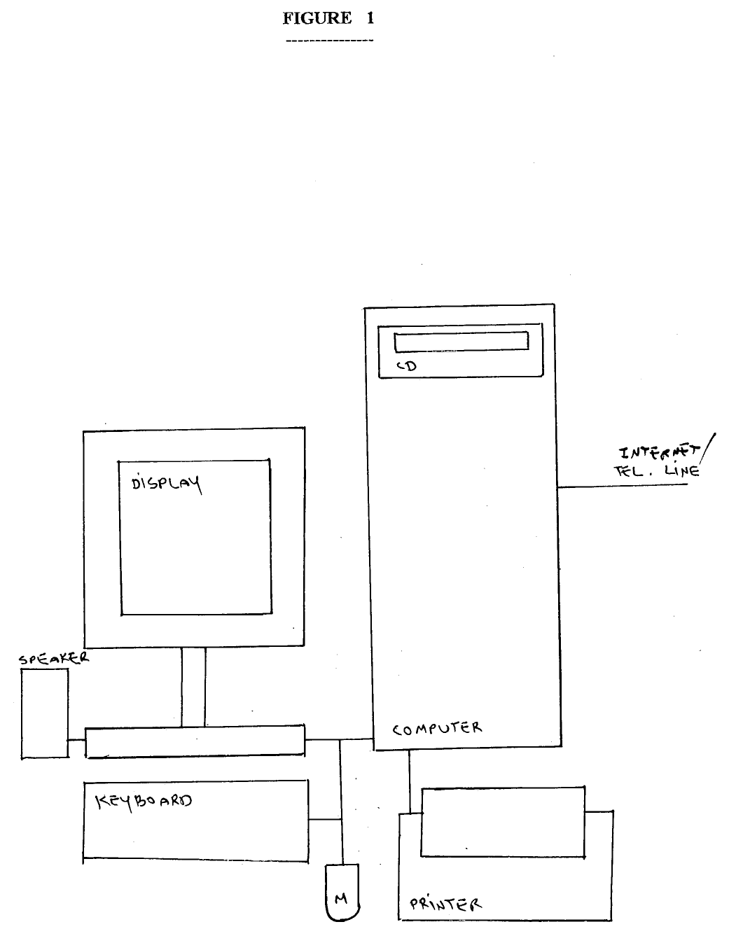

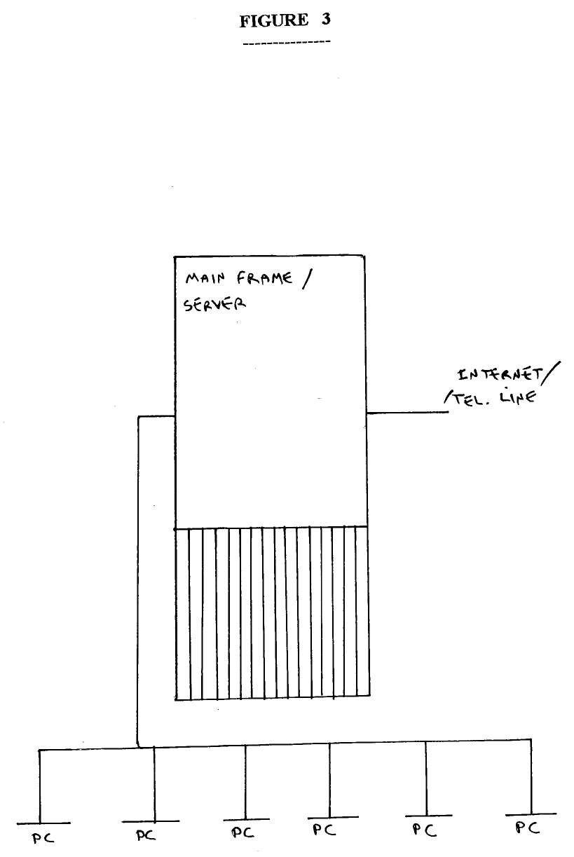

page 6 to page 9—FIG. 1/4 to FIG. 3/4

page 10—FLOW CHART 1/3 to FLOW CHART 3/3

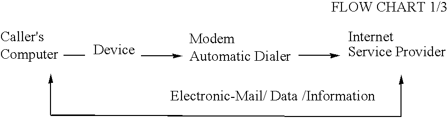

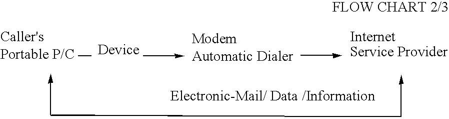

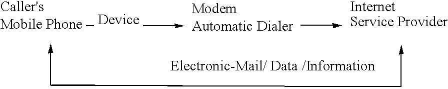

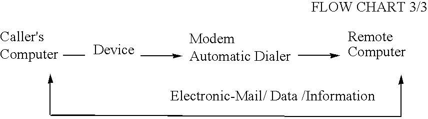

### EXAMPLES

(1) A caller wishes to automatically retrieve and send e-mail via his service provider approximately every hour during working hours 9 to 5.

The User sets the automatic dial to select dialing time between 9:00 to 9:05; 10:00 to 10:05; 11:00 to 11:05 . . . 4:50 to 4:55.

The device will select a random time choice between the limits given and allow the computer retrieve all outstanding e-mail.

When the call results in actual mail being retrieve the device induces a sign that appear on the caller's computer screen to indicate such.

The sign is a mark that appears and keeps changing shape to attract the user's attention. The sign will continue to appear until the status of the mail changes from unread to read. A separate mark on the screen indicates the number of successful e-mail sent and the number of failed e-mail sent.

(2) A caller wishes to automatically retrieve e-mail from his service provider approximately twice a day Monday to Friday at 8:30 a.m. And 3:30 p.m. The user sets the automatic dial to select dialing time between 8:15 to 8:30 a.m. and 3:15 to 3:30 p.m. Monday to Friday.

The chameleon sign on his portable computer screen continue to change color until the first message is read.

(3) A caller wishes to automatically retrieve data from a Remote Computer approximately every 20 Minutes, 24 hours a day, seven days a week.

The data is weather information gathered automatically by the remote computer to be automatically analyzed along other data in a central computer that is programmed to produce weather forecasts.

The device will retrieve the data to the caller's computer according this time instruction by setting the time limits for the random dial to be between 00:20:00 to 00:20:10 ; 00:40:00 to 00:40:10 . . . and continue to do so indefinitely at the same frequency.

(4) A caller wishes to automatically retrieve e-mail from his service provider to be read approximately four times a day at 10 a.m., 1 p.m. 5 p.m and 9 p.m.

The user sets the automatic dial to select dialing time between 9:45 to 9:55 a.m. and 12:45 to 12:55 p.m. . . . 8:45 to 8:55 p.m.

A trumpet sounding sound track through the Mobile phone's speakers at a frequency of every 20 seconds alerts the user until the first message is read.

### DETAILED DESCRIPTION OF THE INVENTION

The caller operates the device through the CONTROL PANEL.

The various control buttons trigger data and information which appear on the display.

The information given via the display confirms the instruction given, display data and communicates with the caller. The control buttons appear on the display or the computer's monitor and are to be operated by the use of a Mouse or Keyboard.

The following are the NAMES of the controls and what they do

| CON- | |
|---|---|
| TROL | FUNCTION |
| Dial Mode | This control indicates the setting of the device to engage |
| & | in automatic retrieval mode. It will become operational when |
| Program | the computer/mobile phone is switched on and will go into |
| | idle mode when the computer/mobile phone is switched off. |
| | A dialing program has to be specified. The device will auto- |
| | matically activate the last dialing program that was inserted, |
| | each time the computer/mobile phone is switched on. |
| Dial Time | This control allows the user to determine the number of |
| Window | seconds or minutes that the Random Time Frequency Gen- |
| | erator can choose from to engage in a dial. That is the time |
| | gap between the upper and lower time limits. That gap make |
| | up the Dial Time Window. |
| Dial | This control determines how many dial attempts are to be |
| Attempts | made during each Time Window. The device divides the al- |
| | lotted time into equal parts equivalent to the number of |
| | attempts computed by the user, and use each of these sub |
| | windows as the upper and lower limit for each dial attempt. |
| | As soon as successful dial occurs the dialing, for this |
| | particular Time Window, stops. |
| First Dial | This control allows the user to determine the lower time limit |
| | for the first Dial Time Window. This is a specified time in |
| | hours and minutes and the date that marks the beginning of |
| | the dial program. |
| Dial | This control determines the number of minutes or hours that |
| Frequency | laps between the lower limit of each Time Window and the |
| | lower time limit of the next Time Window. |
| Number | This control determines the total number of Time Windows |
| of Time | that are included in this particular dial program. This control |
| Windows | guides the the user through the choice of the number of Time |
| | Windows per day, which days of the week and which weeks |
| | of the year are to be included in this particular dialing |
| | program. |
| Retrieval | This control stipulates dials that will include Retrieval only. |
| only | It can apply to all time entries or only to some. The device |
| | will display all possible choices when computing each dialing |
| | program and the user has to make the choice/s. |
| Send only | This control stipulates dials that will include Send only. |
| | It can apply to all time entries or only to some. The device |
| | will display all possible choices when computing each dialing |
| | program and the user has to make the choice/s. |
| Retrieval | This control stipulates dials that will include Retrieve and |
| & Send | Send. It can apply to all time entries or only to some. The |
| | device will display all possible choices when computing each |
| | dialing program and the user has to make the choice/s. |
| View | This control allows the user to view the actual dialing and |
| Program | re-dialing time and all details for a completed dial program. |
| | Without any additional instruction it will display the last or |
| | current program. |
| Save | This control allows the user to save the current program and |
| Program | assign to it a number and name for future reference. |
| Service | This control allows the user to compute the service provider's |
| provider | telephone number for automatic connection to remote |
| | computer. This function goes automatically to a skip mode |
| | after the first entry. |
| User's | This control allows the user to compute his password before |
| Password | commissioning each dial program. Stored programs do not |
| | include the password used. Password has to be freshly |
| | computed before the beginning of each program, unless other- |
| | wise stated. |
| Signal- | This control allows the user to choose from a pre-determined |
| Retrieval | list of different screen signals of different shapes and colors |
| | that will appear on the user's screen, be it stationary or |
| | portable p/c or mobile phone. The signal may appear and |
| | disappear, change color and/or shape as soon as a retrieval |
| | attempt is successful. It may indicate how many items were |
| | retrieved. |
| Signal- | This control allows the user to choose from a pre-determined |
| Send | list of different screen signals of different shapes and colors |
| | that will appear on the user's screen, be it stationary or |
| | portable p/c or mobile phone. The signal may appear and |
| | disappear, change color and/or shape as soon as a send |
| | attempt is successful. It may indicate how many mail items |
| | were successful send and how many failed. |
| Buzzer- | This control allows the user to choose from a pre-determined |
| Retrieval | list of different music tracks and sound effects to be sounded |
| | via the user's computer's or mobile phone speakers triggered |
| | by successful retrieval |
| Buzzer- | This control allows the user to choose from a pre-determined |
| Send | list of different music tracks and sound effects to be sounded |
| | via the user's computer's or mobile phone speakers triggered |
| | by successful send. |
| Suppress | This function allows the user to temporarily suppress each |
| Buzzer | buzzer, retrieve buzzer, send buzzer, or both. |
| ReDo | Allows the user to wipe out the last entry of any computer |
| | data and re-insert the required instruction. |
| Clock/ | This control allows the user to check and if necessary to adjust |
| Calendar | clock and calendar readings currently in use to execute dialing |
| | programs. The clock function remains active when the device |
| | is idle during the time that the computer/mobile phone is |
| | switched off. |
| Options | This control allows the user to compute dialing programs |
| | whereby each element in a dialing program is to be |
| | individually inserted. That may be the case if the Time |
| | Windows may be of unequal length for different times of the |
| | day or week, different number of attempts for each Time |
| | Window and the structure of the Time Windows over time. |
| | This function may be used to change data during each |
| | program. If the user starts off by using the OPTION function, |
| | he is then obligates to individually compute each entry in the |
| | entire program. The program may contain one dial only or any |
| | number of dials. |

1. A device that automatically calls on an Internet Service Provider or a Remote Computer and retrieves or sends electronic mail, information or data that enables the caller to insert dialing time instructions via a Random Time Frequency Generator that determines the dialing time between lower and upper time limits, and is able to divide the allotted time into equal parts equivalent to the ‘number of attempts’ computed by the caller and use each of these sub windows as upper and lower time limits for each re-dial attempt.

2. A device as in claim 1 that automatically calls on an Internet Service Provider or a Remote Computer and retrieves or sends electronic mail, information or data that enables the caller to insert re-dialing time instructions via a Random Time Frequency Generator that determines the re-dialing time between lower and upper time limits, and is able to divide the allotted time into equal parts equivalent to the ‘number of attempts’ computed by the caller and use each of these sub windows as upper and lower time limits for each re-dial attempt.

3. A device as claimed in claims 1 and 2 that automatically calls on an Internet Service Provider or a Remote Computer and retrieves or sends electronic mail, information or data that enables the caller to determine the lower time limit of the first Dial Time Window for the dialing to begin.

4. A device as claimed in any of the preceding claims that allows the caller to determine the total number of Time Windows to be included in a Dialing Program for each day and week of the year (Number of Time Windows).

5. A device as claimed in any of the preceding claims that allows the caller to determine the number of minutes or hours that laps between the lower time limit of each Time Window and the lower time limit of the next Time Window (Dial Frequency).

6. A device as claimed in any of the preceding claims that is equipped with an ‘Options’ function that allows the caller to determine Time Windows of unequal length and a dialing program whereby each element is individually computed.

7. A device as claimed in any of the preceding claims that allows the caller to determine ‘Retrieval only’ or ‘Send only’ or ‘Retrieval and Send’.

8. A device as claimed in any of the preceding claims that allows the caller to select a 'screen signals’ that appears as soon as a ‘Retrieval’ and or ‘Send’ proves successful.

9. A device as claimed in any of the preceding claims that allows the caller to select a ‘Sound Buzzer’ that is triggered as soon as a ‘Retrieval’ and or ‘Send’ proves successful.

10. A device as claimed in any of the preceding claims that allows the caller to determine a ‘User Password’ to commission each dialing program.

11. A device as claimed in any of the preceding claims that is built into a Server or Main Frame Computer.

12. A device as claimed in any of the preceding claims that is built into a Portable Computer with Internet or Remote Computer connection.

13. A device as claimed in any of the preceding claims that is built into a Stationary Personal Computer with Internet or Remote Computer connection.

14. A device as claimed in any of the preceding claims that is built into a Mobile phone with Internet connection.
